(19) United States
(12) Patent Application Publication
(10) Pub. No.: US 2004/0123575 A1
(43) Pub. Date: Jul. 1, 2004

(54) Adjusting device for a harvesting attachment

(76) Inventor: Clemens Rickert, Stadtlohn (DE)

Correspondence Address: Kevin J. Moriarty, Patent Department, DEERE & COMPANY, One John Deere Place, Moline, IL, 61265-8098, US

(21) Appl. No.: 10/688,044

(22) Filed: Oct. 17, 2003

(30) Foreign Application Priority Data
Oct. 29, 2002 (DE) 102 50 337.0

(51) Int. Cl. A01D 34/03

(52) U.S. Cl. 56/14.7

(57) ABSTRACT

An adjusting device for a movable element of a harvesting attachment is provided with an adjusting drive for moving the movable element between a first operating position and a second transport position in which it is raised relative to the first operating position. A spring biases the movable element in the direction of the second transport position.

### FIELD OF THE INVENTION

The present invention is directed to an adjusting device for a movable element of a harvesting attachment wherein a spring is used to bias an adjusting drive towards an equilibrium position.

### BACKGROUND OF THE INVENTION

Since the width of motor vehicles that can drive on roads is limited by law, it is a common practice in agricultural vehicles to fold harvesting attachments between an operating position and a transport position. In the operating position movable elements of the harvesting assembly are oriented parallel to the ground, and in the transport position they are pivoted upward by an angle of approximately 90° or inward by an angle of approximately 180°, in order to reduce the width of the harvesting attachment in the transport position. For example, it is possible to pivot only outer side sections upward or inward, or to pivot two halves of a centrally divided harvesting attachment upward.

Three phases of such a pivoting process are illustrated in FIG. 1. FIG. 1a shows the operating position of a harvesting attachment 10 comprising a central section 12, to be attached to a harvesting vehicle, a left side section 14 that is coupled to the left side of the central section 12 by a pivot shaft 18 that extends horizontally in the forward driving direction, and a right side section 16 that is coupled to the right side of the central section 12 by a pivot shaft 18 that extends horizontally in the forward driving direction. In this operating position, the sections 12-16 are oriented horizontally in order to harvest plants on a field. In the intermediate position shown in FIG. 1b, the side sections 14 and 16 are pivoted inward and upward about the pivot shafts 18 by approximately 115°. In the transport position shown in FIG. 1c, the side sections are pivoted inward 180° such that they lie above the central section 12, reducing the width of the harvesting attachment.

The forces required to pivot the side sections 14 and 16 are usually applied by hydraulic cylinders. The forces to be applied by the adjusting drive initially increase, beginning from the operating position, and ultimately drop after reaching a maximum. An approximate equilibrium exists, in the intermediate or equilibrium position shown in FIG. 1b, i.e., the adjusting drive hardly needs to apply any force to hold the side sections 14 and 16. During the continued pivoting process, the forces are reversed because the adjusting drive no longer needs to lift, but only to support the side sections 14 and 16. When the side sections 14 and 16 are moved back into the operating position, the adjusting drive needs to generate forces of identical intensity, but, in the opposite direction. The adjusting drives need to have sufficiently large dimensions to generate the force maxima that occur shortly after the beginning of the pivoting movement.

U.S. Pat. No. 3,683,601 proposes a cutting unit for a combine wherein a spring is arranged between the adjusting drive and the respective cutting unit halves that can be raised. In the operating position, this spring allows a pendulum motion of the cutting unit that is intended to prevent damage in case the cutting unit hits an obstacle when it is pivoted into the transport position. However, this spring does not affect the maximum values of the pivoting forces to be generated.

DE 100 05 509 A describes a suspension for work modules in the form of mowers that are attached to both sides of a carrier vehicle. The mowers are suspended on tension springs in order to define the contact force of the mowers upon the ground. Hydraulic cylinders are used to pivot the mowers between an operating position and a transport position, wherein the mowers are pivoted inward and upward by approximately 90°. In this case, the only purpose of the springs consists in defining the contact force of the mowers upon the ground.

### SUMMARY OF THE INVENTION

It is an object of the present invention to provide an improved adjusting device for a harvesting attachment.

The harvesting attachment comprises a movable element and an adjusting drive that is able to move said element between a first position and a second position. In the second position, the center of gravity of the element is raised relative to the first position. This means that the adjusting drive needs to generate a force or power in order to move the element from the first position into the second position against the force of gravity. The invention proposes to bias the element in the direction of the second position by means of a spring. This lowers the power or force to be generated by the adjusting drive. The adjusting drive is able to pivot and/or displace the element between the first and the second position. In other respects, it would also be conceivable to utilize a weight instead of a spring. Although the utilization of a weight may make sense in certain applications, a spring is usually more advantageous due to its lower mass.

This means that the adjusting drive can be realized with smaller dimensions, so that it is less expensive and can operate faster than conventional adjusting devices.

In numerous harvesting attachments, the element can be pivoted upward into a transport position by 90°. Examples of such attachments are cutting units comprising two halves. The utilization of the invention in harvesting attachments of this type is advantageous because the forces to be generated for pivoting the elements (e.g., halves of cutting unit) upward from the first position or operating position into the second position or transport position are reduced. Lowering of the elements against the spring bias can be achieved by the means of gravitational force and/or the adjusting drive, which in this case operates in the opposite direction.

In other embodiments the element is moved from the first position into a third position via a second position, with the center of gravity of the element in the third position being situated below the center of gravity in the second position. This means that the adjusting drive also needs to generate a force or power in order to move the element from the third position into the second position. In embodiments of this type, it is advantageous to utilize a spring that biases the element in the direction from the third position into the second position in order to also reduce the force or power to be generated by the adjusting drive in this case. The spring may consist of the same spring that biases the element in the direction from the first position to the second position (i.e., a spring that can be compressed as well as extended), or of a separate spring.

One application for such an adjusting device is a harvesting attachment in which the element can be moved between an operating position (first position) and a transport position (third position) via an intermediate position (second position). Such harvesting attachments consist, for example, of corn heads or corn pickers with side sections that can be pivoted upward and inward. If the pivoting angle of the element is greater than 90°, the adjusting drive initially needs to generate a force for lifting the element against the gravitational force in order to move said element from the operating position into the transport position. After the intermediate position, the center of gravity of the element is lowered again. When moving the element from the transport position into the operating position, it also needs to be initially lifted. Both movements are assisted by the spring or the springs. In addition, the springs absorb some of the force that usually needs to be absorbed by the adjusting drive when the element is lowered.

In such instances, an equilibrium position is reached between the first and the third position of the element wherein the adjusting drive, in principle, does not have to generate any force to hold the element in this equilibrium position. It is advantageous if the above-mentioned second position coincides with the equilibrium position. The spring or springs biases the element toward the equilibrium position. The springs assist the adjusting drive in moving the element from the operating or transport position into the equilibrium position. Beyond the equilibrium position, the element is moved into the transport or operating position by gravitational force, so that the force or power to be generated by the adjusting drive is reduced.

In one preferred embodiment, the spring or the springs is/are arranged within the housing of the pivoting drive that normally comprises a hydraulic cylinder. However, it is also possible to arrange the spring or springs outside the housing, so that conventional pivoting drives can also be utilized. One adjusting drive is able to move one or more elements.

### BRIEF DESCRIPTION OF THE DRAWINGS

FIG. 1, is a schematic rear view of a harvesting attachment that is situated in the operating position in FIG. 1a, in an intermediate or equilibrium position in FIG. 1b, and in the transport position in FIG. 1c.

FIG. 2 is a perspective view of the harvesting attachment, that is situated in the operating position in FIG. 2a and in the transport position in FIG. 2b.

FIG. 3 is a curve illustrating the force progressions occurring during pivoting of the side sections.

FIG. 4 is a cross sectional view of a hydraulic cylinder for pivoting one of the side sections.

### DETAILED DESCRIPTION

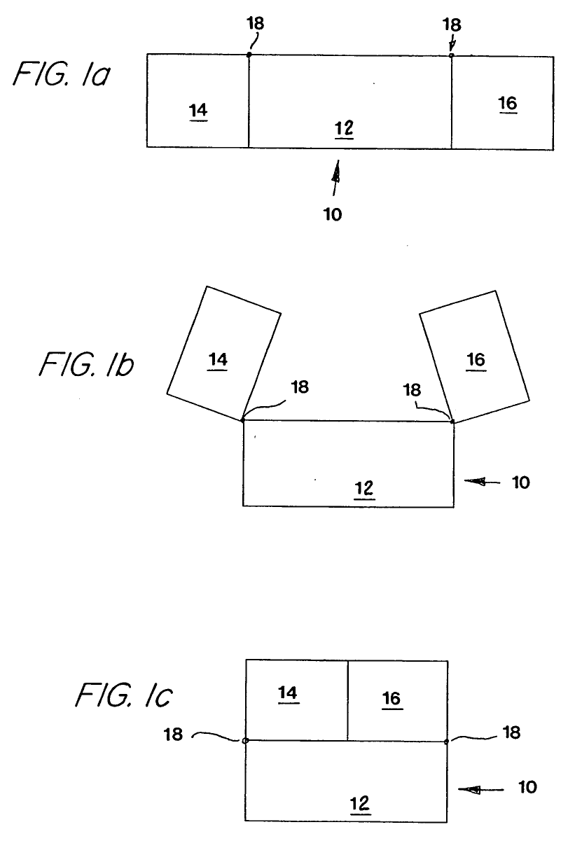

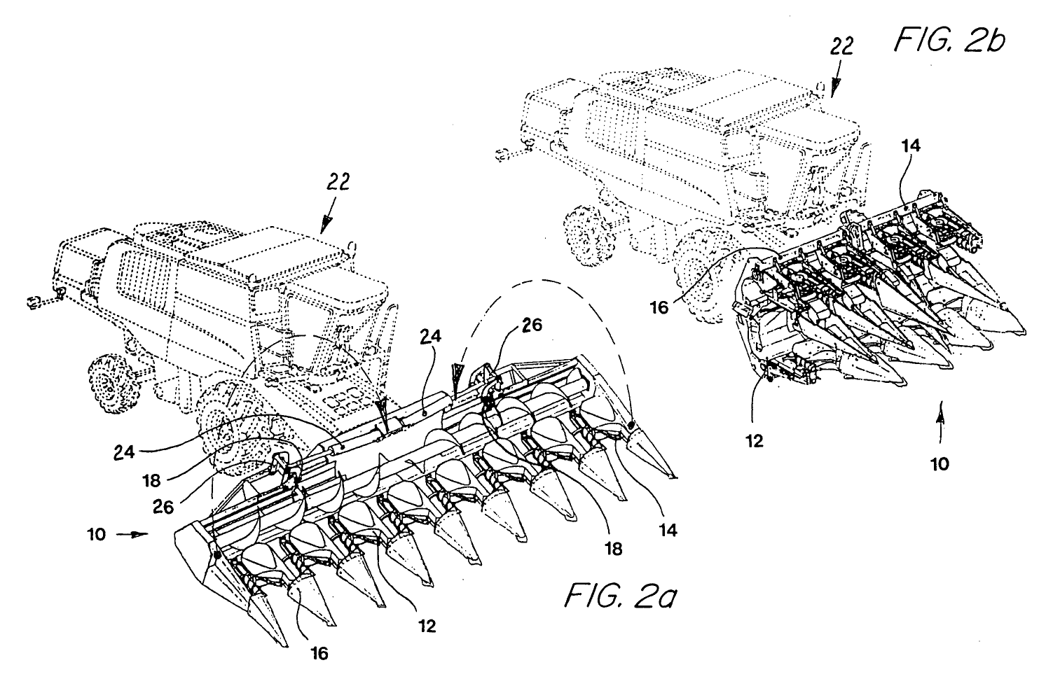

The harvesting attachment 10 described above with reference to FIG. 1 is illustrated in greater detail in FIG. 2. The harvesting attachment 10 comprises a corn picker that is arranged on the feeder house of a combine 22. The central section 12 and the side sections 14 and 16, respectively, comprise four and two known gathering and picking devices with gathering elements that rotate about the horizontal axis and draw plants into a picking gap during operation of the combine. The crop (ears of corn) from the plants is fed to the combine 22.

In order to reduce the width of the harvesting attachment 10 when driving on public roads the attachment can be folded as illustrated in FIG. 2b. Two hydraulic cylinders 24 that extend transverse to the driving direction of the combine 22 are coupled to the upper side of the frame of the central section 12 for pivoting the side sections 14 and 16 about pivot shafts 18 that are rigidly attached to the central section and extend in the driving direction. The piston rods of the hydraulic cylinders 24 are connected to the upper sides of frames of the side sections 14 and 16 by means of mounting supports 26. When acted upon by the hydraulic cylinders 24, the mounting supports 26 convert the linear movements of the hydraulic cylinders 24 into pivoting movements, so that the side sections 14 and 16 are pivoted upward and inward about the pivot shafts 18, which is shown in FIG. 2b. In the operating position (FIG. 2a), the side sections 14 and 16 are aligned parallel to the central section 12 and, for example, are rigidly connected to it due to gravitational force and/or appropriate action of the hydraulic cylinder 24 and/or latching elements. The hydraulic cylinders 24 consist of double-action cylinders, since lifting forces need to be generated at the beginning of each pivoting movement (from the operating position into the transport position and vice versa).

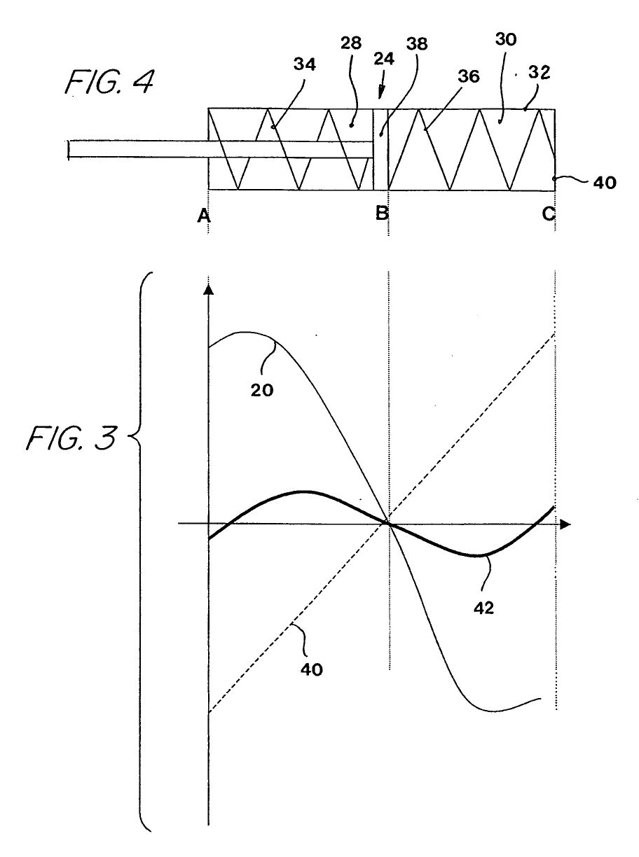

As mentioned above, pivoting forces that vary over time need to be generated when the side sections 14 and 16 of the harvesting attachment 10 are pivoted. In FIG. 3, these pivoting forces are illustrated in the form of the line 20 that represents the progression of forces as a function of the travel of a hydraulic cylinder 24 causing the pivoting movement. When one of the side sections 14 or 16 is raised from the operating position (FIG. 1a, A in FIG. 3), the piston rod chamber 28 (see FIG. 4) of the hydraulic cylinder 24 is pressurized. A relatively high force needs to be generated initially which subsequently decreases again after a maximum is reached, with said force being reduced to zero in the equilibrium position shown in FIG. 1b (B in FIG. 3), and subsequently assumes negative values. Shortly before the transport position (FIG. 1c, C in FIG. 3) is reached, the force, which is no longer compressive but rather tensile because the respective side section 14 or 16 is pulled downward by gravity, reaches another maximum and then slightly decreases again.

The piston chambers 30 of the hydraulic cylinders 24 are pressurized analogously when the side sections 14 and 16 are moved from the transport position into the operating position. Increasing forces initially need to be generated, which soon decrease and are transformed from compressive forces into tensile forces after the elements have passed the equilibrium position shown in FIG. 1b. The line 20 corresponds to the forces to be generated by conventional adjusting drives.

In conventional harvesting attachments, the two force maxima determine the dimensions and the operating speed of the hydraulic cylinders 24. According to the invention, springs 34 and 36 are arranged within the housing 32 of the hydraulic cylinders 24 in order to allow the utilization of smaller hydraulic cylinders 24. A first coil spring 34 is arranged between the end of the housing 32 of the hydraulic cylinder 24 on the piston rod side and the piston 38, and a second coil spring 36 is arranged between the piston 38 and the bottom 40 of the housing 32 of the hydraulic cylinder 24. The springs 34 and 36 exert forces upon the piston 38 which tend to move the piston into its central position, which approximately corresponds to the equilibrium or intermediate position of the side sections 14 and 16 shown in FIG. 1b. The forces exerted upon the piston 38 by the springs 34 and 36 are illustrated in the form of the line 40 in FIG. 3. The line 42 characterizes the resultant force profile.

The springs 34 and 36 lower the forces to be generated by the piston 38 significantly in comparison with instances in which no springs 34 and 36 are provided. This means that the hydraulic cylinders 24 can have smaller dimensions and that faster pivoting speeds can be achieved.

FIGS. 3 and 4 show that, when the piston 38 is in the position A which corresponds to the position shown in FIG. 1a, the spring 34 biases the piston 38 in the direction of the position B that corresponds to the position shown in FIG. 1b. In this situation, the spring 36 remains ineffective. Analogously, the spring 36 prestresses the piston 38 in the direction of the position B if it is in the position C. In this case, the spring 34 remains ineffective. This means that the forces to be generated by the piston 38 are significantly reduced.

The dimensions of the springs 34 and 36 may also be chosen such that they exert forces upon the piston 38 in the equilibrium position. However, in this case these forces balance one another. One advantage of this can be seen in the fact that a steeper force increase can be attained. It should also be noted that the total forces initially appearing in the operating position and the transport position which are directed oppositely to the further force progression can be counteracted by choosing the dimensions of the springs 34 and 36 differently and/or by pressurizing upon the hydraulic cylinders 24.

The springs 34 and 36 could also be arranged outside the housing 32 of the hydraulic cylinders 24. It would also be conceivable to utilize only a single spring that can be compressed and extended, and the idle position of which at least approximately coincides with the equilibrium position (FIG. 1b).

Having described the illustrated embodiment, it will become apparent that various modifications can be made without departing from the scope of the invention as defined in the accompanying claims.

1. An adjusting device for a movable element of a harvesting attachment, the adjusting device is provided with an adjusting drive for moving the movable element between an operating position and a transport position in which the movable element is raised relative to the operating position, characterized by the fact that the movable element is biased in the direction of the transport position by a spring.

2. The adjusting as defined by claim 1 wherein the movable element can be moved from the operating position into the transport position via an intermediate position in which the movable element is raised relative to the transport position, and by the fact that an additional spring biases the movable element toward the intermediate position from the transport position.

3. The adjusting device as defined by claim 2 wherein the intermediate position represents an equilibrium position of the movable element.

4. The adjusting device as defined by claim 3 wherein the movable element is rigidly connected to the harvesting attachment in the operating position.

5. The adjusting device as defined by claim 4 wherein the movable element is pivoted.

6. The adjusting device as defined by claim 5 wherein the movable element comprises a side section that is articulated to a central section of the harvesting attachment in a pivoted fashion.

7. The adjusting device as defined by claim 1 wherein the movable element is pivoted.

8. The adjusting device as defined by claim 7 wherein the movable element comprises a side section that is articulated to a central section of the harvesting attachment in a pivoted fashion.

9. The adjusting device as defined by claim 2 wherein the movable element comprises a side section that is articulated to a central section of the harvesting attachment in a pivoted fashion.

10. The adjusting device as defined by claim 1 wherein the adjusting drive is provided with a housing, the spring is arranged within the housing.

11. The adjusting device as defined by claim 10 wherein the adjusting drive is a double acting hydraulic cylinder.

12. The adjusting device as defined by claim 2 wherein the adjusting drive is provided with a housing, the spring and the additional spring are arranged within the housing.

13. The adjusting device as defined by claim 9 wherein the adjusting drive is provided with a housing, the spring and the additional spring are arranged within the housing.

14. The adjusting device as defined by claim 13 wherein the adjusting drive is a double acting hydraulic cylinder.
